(19) United States
(12) Patent Application Publication
(10) Pub. No.: US 2003/0137535 A1
(43) Pub. Date: Jul. 24, 2003

(54) Display system with screen shut-off function and method of controlling same

(75) Inventor: Jae-Cheol Heo, Suwon-City (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon City (KR)

(21) Appl. No.: 10/216,236

(22) Filed: Aug. 12, 2002

(30) Foreign Application Priority Data
Jan. 21, 2002 (KR) 2002-3314

(51) Int. Cl. G09G 5/00

(52) U.S. Cl. 345/741; 345/867

(57) ABSTRACT

A display system displaying a video signal on a display part includes an input part through which a user sets a time, a timer providing present time information, an OSD generator activating an OSD on the display part, and a controller. The controller controls the OSD generator to activate the OSD covering at least a part of a picture displayed on the display part when the present time transmitted from the timer is within a range of the set time.

### CROSS-REFERENCE TO RELATED APPLICATIONS

This application claims the benefit of Korean Application No. 2002-3314, filed Jan. 21, 2002, in the Korean Patent Office, the disclosure of which is incorporated herein by reference.

### BACKGROUND OF THE INVENTION

1. Field of the Invention

The present invention relates in general to a display system having a screen shut-off function and a method of controlling same, and more particularly, to a display system having a screen shut-off function and a method of controlling the same, in which the screen shut-off function is controlled through an OSD (on screen display) so as to protect minors from harmful contents at a predetermined time slot.

2. Description of the Related Art

Internet and multimedia technology are widely used and, accordingly, a large amount of video data is displayed on a screen on a display apparatus, such as a monitor of a computer system, TV, etc. The video data may contain harmful contents, which create a social problem because minors have easy access to the harmful contents, such as an obscene picture, an immoral program, etc. through the Internet. Therefore, various programs have been developed in order to protect the minors from the video data including the harmful contents, for example, a program has been developed forbidding access to an adult website.

However, these types of programs are not very useful for a minor who is skillful in using the computer system because the minor can easily remove the protection program by hacking a password or by ending the program. Thus, limits exist to forbid the harmful contents from the minor with theses types of software programs.

### SUMMARY OF THE INVENTION

Accordingly, the present invention has been made keeping in mind the above-described shortcomings and a user's need, and an object of the present invention is to provide a display system having a screen shut-off function and a method of controlling the same, in which the screen shut-off function is controlled through an OSD (on screen display) so as to protect minors from harmful contents during a predetermined time slot.

To achieve the above and other objects, the present invention may be accomplished by providing a display system displaying a video signal on a display part, including: an input part through which a user sets a time; a timer providing present time information; an OSD generator activating an OSD on the display part; and a controller controlling the OSD generator to activate the OSD covering at least a part of a picture displayed on the display part when the present time transmitted from the timer is within a range of the set time.

The display system includes a speaker, wherein the controller indicates that a screen shut-off function to shut-off a screen of the display part is operated when the present time transmitted from the timer is within the range of the set time.

The input part includes a message input part to input a predetermined message, and the controller controls the OSD generator to show the predetermined message on the OSD when the present time is within the range of the set time.

The display system includes a password input part to input a password to close the OSD shutting off the screen, wherein the controller controls the OSD generator to close the OSD when the password inputted through the password input part is equal to a previously set password.

To achieve the above and other objects, the present invention may be accomplished by providing a method of controlling a display system displaying a video signal on a display part and having an OSD function activating an OSD overlapping a picture displayed on the display part, including: setting a time for which a screen shut-off function to shut-off a screen of the display part is operated; determining whether the present time is within a range of the set time while the display system is operated; and activating the OSD overlapping at least a part of the picture displayed on the display part when the present time is within the range of the set time.

The activating of the OSD comprises indicating through an audio signal that the screen shut-off function is being operated. The method further includes inputting a message shown on the OSD. The setting of the time includes requesting a user to input a password. The method further includes selecting a close of the OSD shutting off the screen; requesting a user to input a password to close the OSD shutting off the screen; and closing the OSD when the inputted password to close the OSD shutting off the screen is equal to a previously set password.

To achieve the above and other objects, the present invention may be accomplished by providing a display system, including: a display part; a monitor controller receiving a present time, storing a set time and a predetermined message, and outputting a control signal when the present time is within a range of the set time; and an OSD IC activating an OSD to overlap at least a part of a picture displayed on the display part in response to the control signal.

To achieve the above and other objects, the present invention may be accomplished by providing a method of a display system displaying a picture on a display part, including: receiving a present time, storing a set time and a predetermined message, and outputting a control signal when the present time within a range of the set time; and activating an OSD to overlap at least a part of the picture displayed on the display part in response to the control signal.

To achieve the above and other objects, the present invention may be accomplished by providing a method of setting a screen shut-off function of a display system, including: setting an option of the screen shut-off function to shut-off a screen of a display part through an OSD menu of the display system; checking whether a password is set to prevent an unauthorized user from changing the option of the screen shut-off function; storing the set password; requesting a user to input a password when the password is set; checking whether the inputted password is equal to the set password; displaying the OSD menu to set the screen shut-off function when the inputted password is equal to the set password; setting a time through the OSD menu from which the screen shut-off function is operated; and setting a message to be shown on the OSD to shut-off the screen of the display part.

To achieve the above and other objects, the present invention may be accomplished by providing a method of performing a screen shut-off function on a display system, including: displaying a video signal on a screen of a display part; comparing a present time with a set time; determining whether the present time is within a range of the set time; activating an OSD to shut-off the screen of the display part when the present time is within the range of the set time; requesting a user to input a password to close the OSD shutting off the screen by offering an input blank on the screen; checking whether the password inputted through the input blank matches a previously set password; and closing the OSD for a predetermined period of time to close the OSD shutting off the screen when the password matches the password stored.

These together with other objects and advantages, which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The present invention will be better understood and its various objects and advantages will be more fully appreciated from the following description taken in conjunction with the accompanying drawings, in which:

FIG. 1 is a control block diagram of a display system according to an embodiment to the present invention;

FIG. 2 is a flow chart illustrating a process of setting a screen shut-off function of the display system shown in FIG. 1;

FIG. 3 is a flow chart illustrating operation of the screen shut-off function of the display system shown in FIG. 1; and

FIG. 4 illustrates an embodiment of the display system according to the present invention.

### DETAILED DESCRIPTION OF THE PREFERRED EMBODIMENTS

The present invention will be described in more detail with reference to the accompanying drawings.

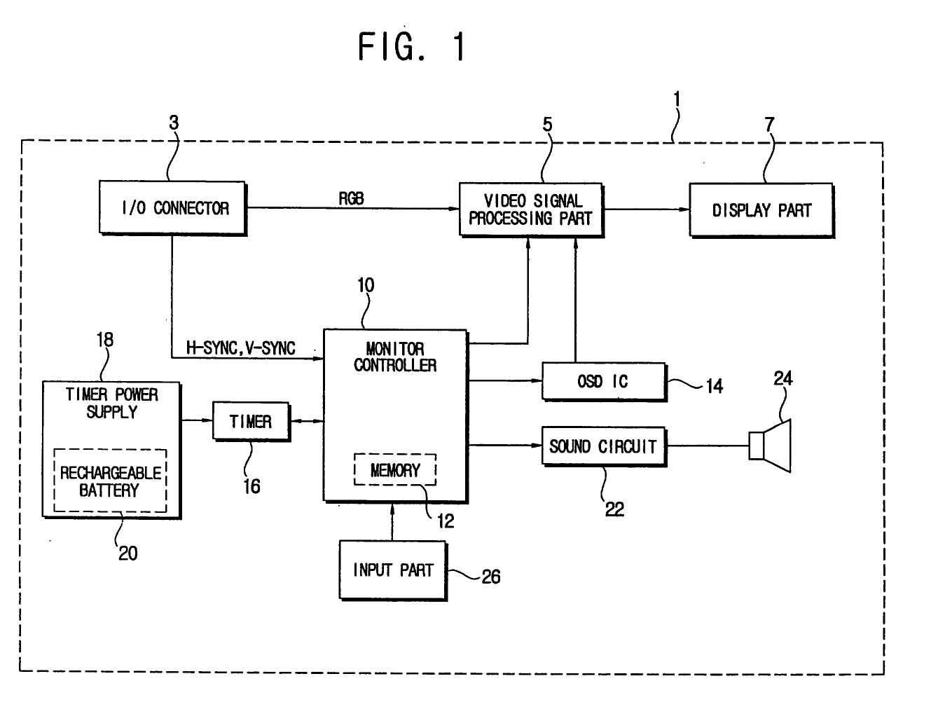

FIG. 1 is a control block diagram of a display system according to an embodiment of the present invention. As shown therein, the display system 1 includes an I/O connector 3 receiving a signal from a computer, a video signal processing part 5 processing RGB signals, a display part 7 displaying a picture thereon, and a monitor controller 10.

The RGB signals inputted through the I/O connector 3 are converted into a video signal adapted to the display part 7 by the video signal processing part 5, and displayed on the display part 7. The monitor controller 10 controls the video signal processing part 5 according to horizontal and vertical synchronous signals from the I/O connector 3, thereby allowing the video signal processing part 5 to synchronize the RGB signals.

Further, the present display system 1 includes an input part 26 through which a user selects a screen shut-off function, a timer 16 transmitting present time information to the monitor controller 10, and a timer power supply 18 supplying electric power to the timer 16. An OSD IC (on screen display integrated circuit) 14 outputs an OSD signal for activating an OSD on the display part 7, and a sound circuit 22 generating a sound signal according to a control signal from the monitor controller 10 and outputting the sound signal to a speaker 24.

The input part 26 is employed to set a time, for which the screen shut-off function is operated, and a predetermined message to be shown on the OSD. Herein, the set time includes on time at which the screen shut-off function starts operating and off time at which the screen shut-off function stops operating. An OSD menu may be employed as the input part 26, or a separate selection button may be employed as the input part 26.

The timer 16 transmits the present time information to the monitor controller 10. Therefore, the timer 16 is operated by the electric power supplied from the timer power supply 18 independently of whether the display system 1 is turned off. Here, a separate power supply, such as a battery, may be employed as the timer power supply 18. Further, the timer power supply 18 may include a rechargeable battery 20. The rechargeable battery 20 may be charged with electric power from an outer power source while the display system 1 is operated using the electric power from the outer power source. The rechargeable battery 20 supplies the electric power to the timer 16 when the display system 1 is turned off.

The OSD IC 14 generates the OSD shutting off a picture displayed on the display part 7 according to a control signal from the monitor controller 10. The monitor controller 10 stores information on a set time and the predetermined message inputted through the input part 26 in a memory 12. Herein, the set time includes on time at which the screen shut-off function starts operating and off time at which the screen shut-off function stops operating. Then, the monitor controller 10 controls the OSD IC 14 to activate the OSD to shut-off the screen of the display part 7 when the present time transmitted from the timer 16 is within a range of the set time. Further, the monitor controller 10 outputs the sound signal according to an option set by the user, so that the sound circuit 22 outputs a warning sound through the speaker 24.

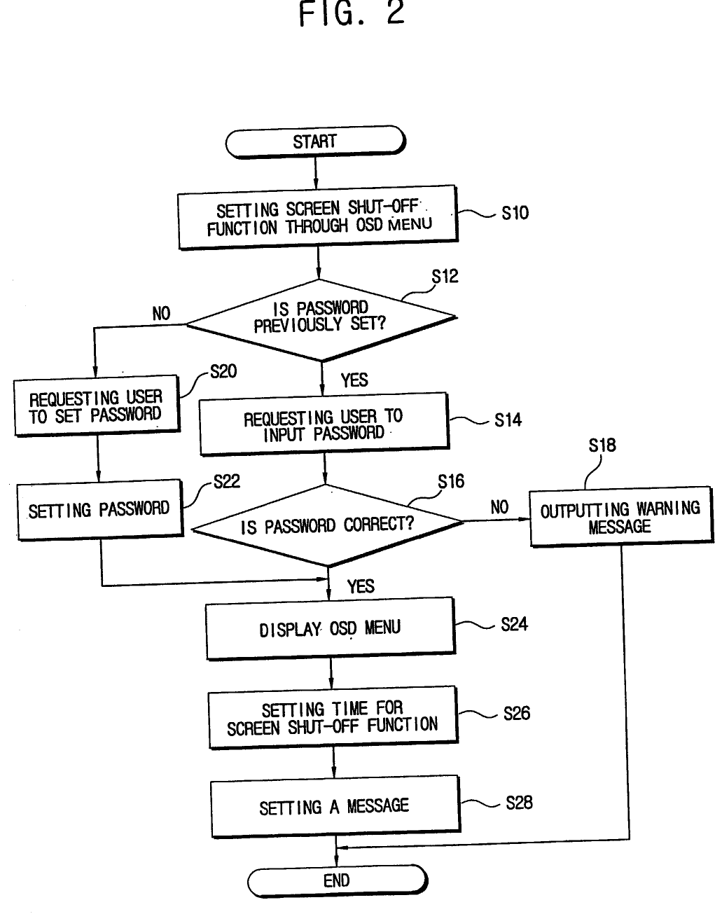

FIG. 2 illustrates a process of setting the screen shut-off function of the display system 1 according to the present invention. At operation S10, to operate the screen shut-off function, the user sets an option of the screen shut-off function through the OSD menu of the display system 1. Then, at operation S12, the monitor controller 10 checks whether or not a password is set. The password prevents an unauthorized user from changing the option of the screen shut-off function.

At operation S20, if the password is not set, the monitor controller 10 requests the user to set the password necessary to change the option of the screen shut-off function. When the user sets the password, at operation S22, the monitor controller 10 stores the set password in the memory 12. Thus, whenever the user sets the password or changes the option of the screen shut-off function, the password may be inputted, thereby preventing the unauthorized user from changing the option of the screen shut-off function, except for the user who can input the correct password.

At operation S14, when the password is set, the monitor controller 10 requests the user to input the password. At operation S16, the monitor controller 10 checks whether or not the inputted password is equal to the set password. At operation S18, if the inputted password is not equal to the set password, the monitor controller 10 outputs a warning message, and requests the user to input the password again, thereby preventing the unauthorized user from changing the option of the screen shut-off function.

At operation S24, if the inputted password is equal to the set password, the monitor controller 10 controls the OSD IC 14 to display the OSD menu to set the screen shut-off function on the display part 7. Then, at operation S26, the user sets the time through the OSD menu, from which the screen shut-off function is operated. Herein, the set time includes on-time at which the screen shut-off function starts operating and off-time at which the screen shut-off function stops operating. Further, at operation S28 the user sets the message to be shown on the OSD to shut-off the screen of the display part 7. Here, another password may be set to close the OSD shutting off the screen.

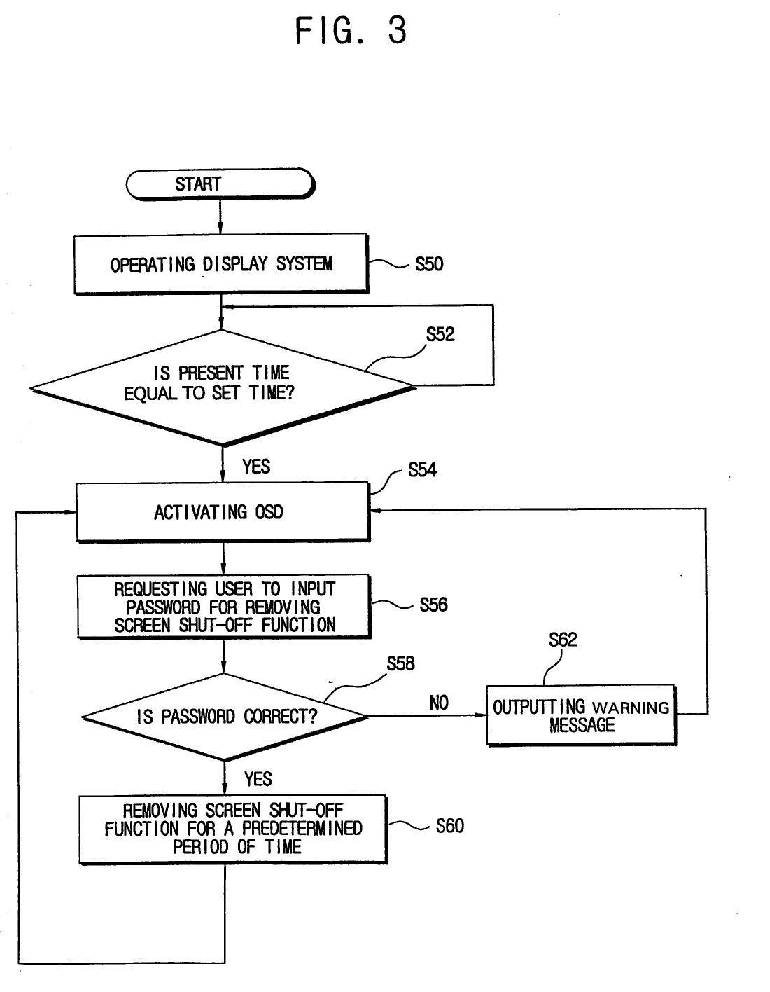

As shown in FIG. 3, after setting the screen shut-off function, the display system 1 performs the screen shut-off function as follows. At operation S50, the display system 1 is operated to display the video signal received from the computer. Simultaneously, at operation S52, the monitor controller 10 compares the present time transmitted from the timer 16 with the set time stored in the memory 12, and determines whether the present time is within the range of the set time. When the present time is not within the range of the set time, the monitor controller 10 controls the video signal received from the computer to be displayed on the display part 7, and continuously checks whether the present time is within the range of the set time. At operation S54, when the present time is within the range of the set time, the monitor controller 10 controls the OSD IC 14 to activate the OSD, shutting off the screen of the display part 7.

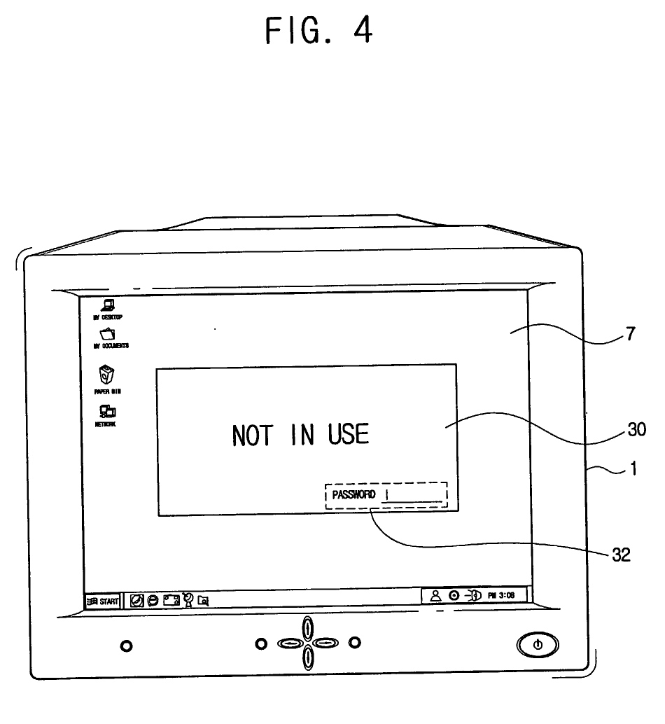

By way of example, as shown in FIG. 4, an OSD 30 is activated on the display part 7 of the display system 1. The OSD 30 covers a picture transmitted from the computer and displayed on the display part 7, thereby shutting off the screen of the display part 7. Herein, the OSD 30 may have various sizes to partially or entirely cover the picture of the display part 7, and may be fixed at a predetermined position. Further, the OSD 30 may be moving with a predetermined size. The OSD 30 shuts off the screen of the display part 7.

Further, the message set by the user may be shown on the OSD 30. Further, in a state that the screen of the display part 7 is shut-off by the OSD, the monitor controller 10 can transmit a predetermined sound signal to the speaker 24, thereby outputting a warning sound. In contrast, referring to FIG. 3, at operation S56, when the user wants to close the OSD 30 shutting off the screen, the monitor controller 10 requests the user to input a password to close the OSD 30 shutting off the screen, offering an input blank 32 (FIG. 4). The password for closing the OSD 30 shutting off the screen may be independently set when the option of the screen shut-off function is set, or be equal to the password to change the option of the screen shut-off function. Further, the input blank 32 may be provided on the OSD 30, or be offered at a request from the user.

Then, at operation S58, the monitor controller 10 checks whether the password inputted through the input blank 32 is correct. When the password is not correct, at operation S62, a warning message is outputted maintaining the screen shut-off function. The warning message can be a visual message shown on the OSD or an audio message outputted to the speaker 24.

When the password is correct, at operation S60, the monitor controller 10 controls the OSD IC 14 to close the OSD 30 for a predetermined period of time, thereby uncovering the screen shut-off by the OSD 30. That is, although the screen is uncovered by closing the OSD 30, if the display system 1 is used within the range of the set time, at operation S54, the OSD 30 is reactivated after an elapse of a predetermined period of time. Thus, even if an authorized user leaves the display system 1, the unauthorized user is prevented from watching the screen of the display system 1 within the range of the set time.

As described above, according to the present invention, during a time set by a user, an OSD to shut-off the screen is activated through an OSD menu provided in a display system. The display system includes a screen shut-off function, thereby preventing the screen shut-off function from being removed by program control or hacking. As described above, the present invention provides a display system having a screen shut-off function and a method of controlling the same, by which minors are protected from harmful contents video data during a predetermined time slot.

Although the preferred embodiments of the present invention have been disclosed for illustrative purpose, those skilled in the art will appreciate that various modifications, additions and substitutions are possible, without departing from the scope and spirit of the invention as disclosed in the accompanying claims.

What is claimed is:

1. A display system displaying a video signal on a display part, comprising:
an input part through which a user sets a time;
a timer providing present time information;
an OSD generator activating an OSD on the display part; and
a controller controlling the OSD generator to activate the OSD covering at least a part of a picture displayed on the display part when the present time transmitted from the timer is within a range of the set time.

2. The display system as recited in claim 1, further comprising a speaker, wherein the controller indicates that a screen shut-off function to shut-off a screen of the display part is operated when the present time transmitted from the timer is within the range of the set time.

3. The display system as recited in claim 1, wherein
the input part comprises a message input part to input a predetermined message, and
the controller controls the OSD generator to show the predetermined message on the OSD when the present time is within the range of the set time.

4. The display system as recited in claim 1, further comprising a password input part to input a password to close the OSD shutting off the screen to remove the screen shut-off function], wherein the controller controls the OSD generator to close the OSD when said password inputted through the password input part is equal to a previously set password.

5. The display system as recited in claim 3, further comprising:
a password input part to input a password to close the OSD shutting off the screen, wherein the controller controls the OSD generator to close the OSD when said password inputted through the password input part is equal to a previously set password.

6. A method of controlling a display system displaying a video signal on a display part and having an OSD function activating an OSD overlapping a picture displayed on the display part, comprising:
setting a time for which a screen shut-off function to shut-off a screen of the display part is operated;
determining whether the present time is within a range of the set time while the display system is operated; and
activating the OSD overlapping at least a part of the picture displayed on the display part when the present time is within the range of the set time.

7. The method as recited in claim 6, wherein the activating of the OSD comprises indicating through an audio signal that the screen shut-off function is being operated.

8. The method as recited in claim 6, further comprising inputting a message shown on the OSD.

9. The method as recited in claim 6, wherein the setting of the time comprises requesting a user to input a password.

10. The method as recited in claim 6, further comprising:
selecting a close of the OSD shutting off the screen;
requesting a user to input a password to close the OSD shutting off the screen; and
closing the OSD when the inputted password to close the OSD shutting off the screen is equal to a previously set password.

11. A display system, comprising:
a display part;
a monitor controller receiving a present time, storing a set time and a predetermined message, and outputting a control signal when the present time is within a range of the set time; and
an OSD IC activating an OSD to overlap at least a part of a picture displayed on the display part in response to the control signal.

12. The display unit as recited in claim 11, further comprising:
a video processing part; and
an I/O connector receiving and processing a signal from a computer to output an RGB signal to the video signal processing part and horizontal and vertical synchronous signals to the monitor controller.

13. The display unit as recited in claim 12, wherein the monitor controller controls the video signal processing part according to the horizontal and vertical synchronous signals from the I/O connector to allow the video signal processing part to synchronize the RGB signals to display the picture on the display part.

14. The display unit as recited in claim 11, further comprising:
an input part allowing a user to select a screen shut-off function and to set the time for which the screen shut-off function is operated and the predetermined message to be displayed on the OSD;
a timer transmitting the present time information to the monitor controller; and
a timer power supply supplying electric power to the timer.

15. The display unit as recited in claim 11, further comprising:
a sound circuit receiving a sound signal from the monitor controller when the present time is not within the range of the set time and outputting a warning sound through a speaker.

16. The display unit as recited in claim 14, wherein the input part comprises one of an OSD menu and a separate selection button.

17. The display unit as recited in claim 14, wherein the timer is operated by the electric power supplied from the timer power supply independently of whether the display system is turned off.

18. The display unit as recited in claim 14, wherein the timer power supply comprises a battery.

19. The display unit as recited in claim 14, wherein the timer power supply comprises a rechargeable battery charged with electric power from an outer power source while the display system is operated using the electric power from the outer power source.

20. The display unit as recited in claim 19, wherein the rechargeable battery supplies the electric power to the timer when the display system is turned off.

21. The display unit as recited in claim 11, wherein the OSD is fixed at a predetermined position or moves with a predetermined size.

22. A method of a display system displaying a picture on a display part, comprising:
receiving a present time;
storing a set time and a predetermined message; and
outputting a control signal when the present time is within a range of the set time; and
activating an OSD to overlap at least a part of the picture displayed on the display part in response to the control signal.

23. The method as recited in claim 22, further comprising:
allowing a user to select a screen shut-off function and to set the time for which the screen shut-off function is operated and the predetermined message to be displayed on the OSD.

24. A method of setting a screen shut-off function of a display system, comprising:
setting an option of the screen shut-off function to shut-off a screen of a display part through an OSD menu of the display system;
checking whether a password is set to prevent an unauthorized user from changing the option of the screen shut-off function;
storing the set password;
requesting a user to input a password when the password is set;
checking whether the inputted password is equal to the set password;
displaying the OSD menu to set the screen shut-off function when the inputted password is equal to the set password;
setting a time through the OSD menu from which the screen shut-off function is operated; and
setting a message to be shown on the OSD to shut-off the screen of the display part.

25. The method as recited in claim 24, further comprising:
requesting the user to set the password necessary to change the option of the screen shut-off function when the password is not set.

26. The method as recited in claim 25, further comprising:
outputting a warning message when the inputted password is not equal to the set password; and
requesting the user to input the password again to prevent the unauthorized user from changing the option of the screen shut-off function.

27. The method as recited in claim 26, wherein the warning message is a visual message shown on the OSD or an audio message.

28. A method of performing a screen shut-off function on a display system, comprising:
displaying a video signal on a screen of a display part;
comparing a present time with a set time;
determining whether the present time is within a range of the set time;
activating an OSD to shut-off the screen of the display part when the present time is within the range of the set time;
requesting a user to input a password to close the OSD shutting off the screen by offering an input blank on the screen;
checking whether the password inputted through the input blank matches a previously set password; and
closing the OSD for a predetermined period of time to close the OSD shutting off the screen when the password matches the previously set password.

29. The method as recited in claim 28, wherein the OSD is reactivated after an elapse of a predetermined period of time to prevent the unauthorized user from watching the screen of the display system during the set time.

30. The method as recited in claim 28, further comprising controlling the video signal to be displayed and continuously checking whether the present time is within the range of the set time.

31. The method as recited in claim 28, wherein the password to close the OSD shutting off the screen is independently set or is equal to a password to change the option of the screen shut-off function.

32. The method as recited in claim 28, wherein the input blank is provided on the OSD at a request from the user.

33. The method as recited in claim 28, wherein the warning message is a visual message shown on the OSD or an audio message.

34. The method as recited in claim 28, further comprising:
outputting a warning message maintaining the screen shut-off function when the password to close the OSD shutting off the screen does not match the previously set password.
